(19) United States
(12) Patent Application Publication
(10) Pub. No.: US 2007/0144018 A1
(43) Pub. Date: Jun. 28, 2007

(54) Height adjustment device for the arm of an engraving machine

(76) Inventor: Louis Tseng, Walnut, CA (US)

Correspondence Address: LAW OFFICES OF J.F. LEE, 17800 CASTLETON STREET, SUITE 383, CITY OF INDUSTRY, CA, 91748, US

(21) Appl. No.: 11/306,351

(22) Filed: Dec. 23, 2005

(51) Int. Cl. B43L 13/00

(52) U.S. Cl. 33/32.3

(57) ABSTRACT

A height adjustment device for the arm of an engraving machine is disclosed herein. Present invention provides a turn knob on a holding piece having threaded portion engaged to a threaded hole on the arm, so that when making height adjustment, the weight of the arm is supported by the present invention, but by user's strength, greatly enhancing the safety of operation and the precision of making such adjustment.

### FIELD AND BACKGROUND OF THE INVENTION

Engraving machines are used extensively in jewelry industry. The general structure of an engraving machine consists of a platform, an engraving arm, and guidepost(s) to which the engraving arm is slidably affixed.

The work piece is placed on the platform during the process of engraving, secured by different mechanism, depending on the size and material of the work piece.

The engraving arm has a base portion that is in slidable connection with one or more guidepost, so that users may move the engraving arm up or down on the guideposts.

A few segments extend out from the base portion of said engraving arm; these segments are interconnected by a few joints, to provide the flexibility and controllability when users are holding the engraving tip to work on the work piece secured on the platform.

Although the base portion of said engraving arm can be moved up/down the guideposts, it is quite awkward to do so because the engraving arm is quite heavy. Traditionally, to change the set height of the engraving arm, one has to loosen the control knob at the back of an engraving machine, while holding the arm to prevent its freefall, propping it up to the desired height along the travel on the guidepost, then tighten the control knob. This way of setting/changing the desired height of the engraving arm requires substantial strength and oftentimes resulting in accidents due to the weight of the engraving arm falling down when the control knob is loosened.

If the falling down of the engraving arm causes damages to the work piece, which could be very expensive, the costs could be disastrous.

To solve this long-standing industry problem, present invention uses the combination of a holding piece and an extra turn-knob to easily adjust and set the desired height of the engraving arm.

### OBJECTS AND SUMMARY OF THE INVENTION

Present invention provides a structure for easy adjustment and setting of the engraving arm on an engraving machine.

By introducing the holding piece and the turn-knob, workers, especially lady workers, would feel at ease in setting/changing the height of the engraving arm, without concern that the engraving arm would fall accidentally and causing further damages to the work piece.

Present invention further enable the height adjustment of an engraving arm to be done in a very precise manner, enable the degree of fine-tuning of the desired height that was not previously possible.

Although there are some prior patents and equipment related to improvements upon engraving machine, or any part thereto, none were aimed towards solving the same problem as the one encountered by present invention; nor were any of these contain similar structural implementation as the present invention.

For example, U.S. Pat. No. 3,937,873, entitled “Engraving Machines” by inventor Paul E. Gastineau (“Gastineau 873 Patent”), disclosed and claimed the implementation (method and apparatus) of an engraving machine for making watermarks, claiming optical reading head as part of the requisite elements of the patent.

Gastineau 873 Patent disclosed and claimed nothing related to the height adjustment of present invention.

U.S. Pat. No. 4,541,760, entitled “Apparatus for drilling, engraving and carving ophthalmic lenses”, by inventor Georges Zoueki (“Zoueki 760 Patent”), disclosed and claimed an apparatus having an electrical motor (among others) and an L-shaped tube having perpendicularly extending portion useful as support for a lens when the lens is drilled, engraved or carved.

Present invention lacks the recited “electrical motor” and the “L-shaped tube” having perpendicularly extending portion support for a lens. Zoueki further disclosed nothing that would help solve the height adjustment problem that is intended by present invention.

U.S. Pat. No. 4,834,595, entitled “Computer Controlled Engraving by a Rotating Milling Tool” by inventor Angelo Cacciotti (“Cacciotti 595 Patent”), disclosed and claimed an apparatus (and method) in which the engraving tool is contained in a housing which has a longitudinal slit parallel to X axis and perpendicular to Z axis.

Present invention has nothing related to Cacciotti 595 Patent's housing or its longitudinal slit. Present invention is not related to Cacciotti 595's claimed “computer controlled engraving”.

U.S. Pat. No. 6,540,453, entitled “Method for Positioning Engraving Members”, by inventor Bernd Lubcke (“Lubcke 453 Patent”), disclosed and claimed the method for “positioning engraving elements in an electronic engraving machine.” Lubcke 453 Patent's claimed method specifically stated to engrave “in the form of cups at least two engraving lanes having predetermined lane widths”.

Lubcke 453 Patent is not analogous art and has nothing to do the present invention's height adjustment mechanism.

U.S. Pat. No. 6,834,434, entitled “Spring-loaded Engraving Toolholder” by inventor Lance Nelson (“Nelson 434 Patent”), disclosed and claimed a toolholder made of a cylindrical body configured to be held in a collet or endmill toolholder. Nelson 434 Patent contains a requisite “compressible element” (which is a spring in its embodiment) to apply a biasing force.

Present invention is structurally not similar to Nelson 434 Patent, nor is there any common problems solved by Nelson 434 Patent.

### DESCRIPTION OF THE DRAWINGS

The accompanying drawings, which are incorporated in and constitute a part of this specification, illustrate the preferred embodiment of the invention and together with the description, serve to explain the principles of the invention.

A brief description of the drawings is as follows:

FIG. 1 shows the prior art embodiment of an engraving machine.

FIG. 2 shows a perspective view of the implementation of present invention.

FIG. 3 shows a partial perspective view of present invention from the back of an engraving machine.

FIG. 4 shows the top view of present invention.

### DETAILED DESCRIPTION OF THE PREFERRED EMBODIMENT

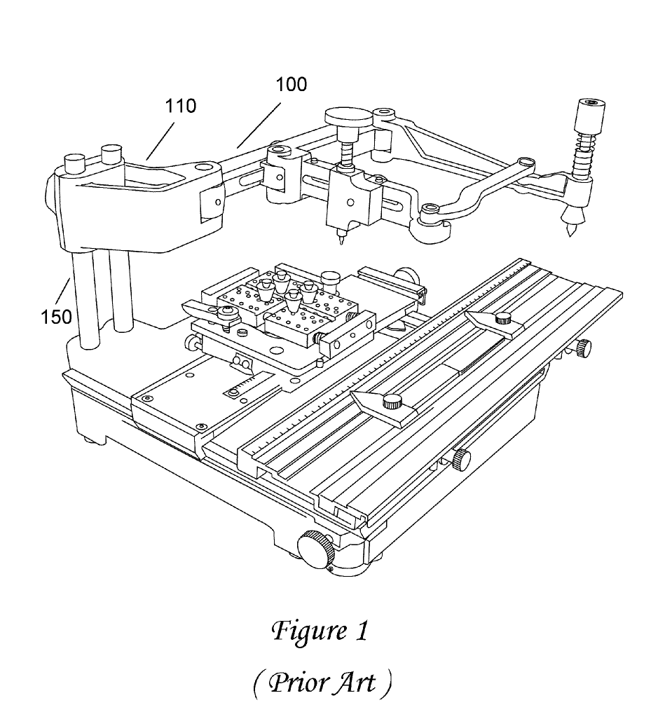

FIG. 1 shows a traditional engraving machine. The engraving arm 100 has a base portion 110 and a couple of guideposts 150 erected from one side of the platform 90.

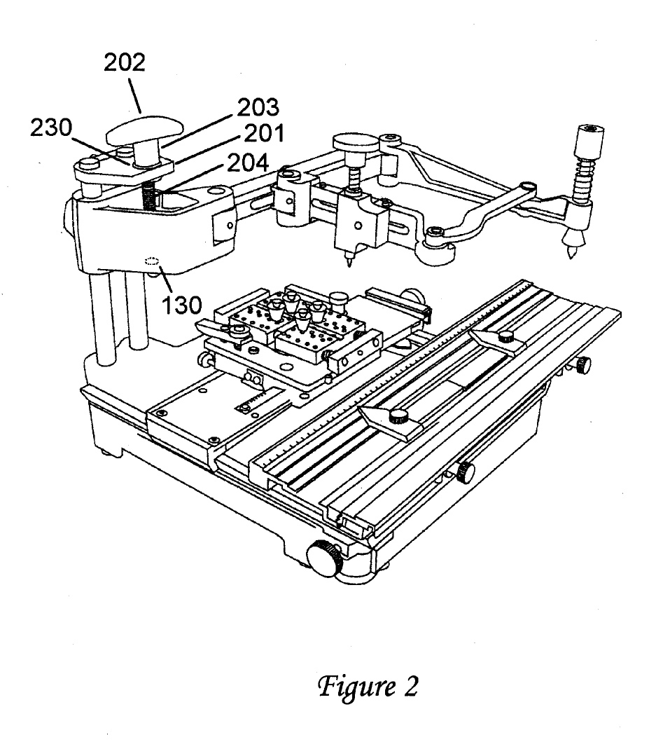

FIG. 2 shows an implementation of present invention where a holding piece 201 is secured to the top of the guideposts 150.

A turn knob 202 contains a threaded segment 204 that can be fittedly spiraling through a threaded hole 130 on the base portion 110 of the engraving arm.

On the holding piece 201, there is formed an aperture 230 allowing the upper portion of turn knob 202 to be turned or handled without changing the turn knob's 202 vertical displacement relative to said holding piece 201.

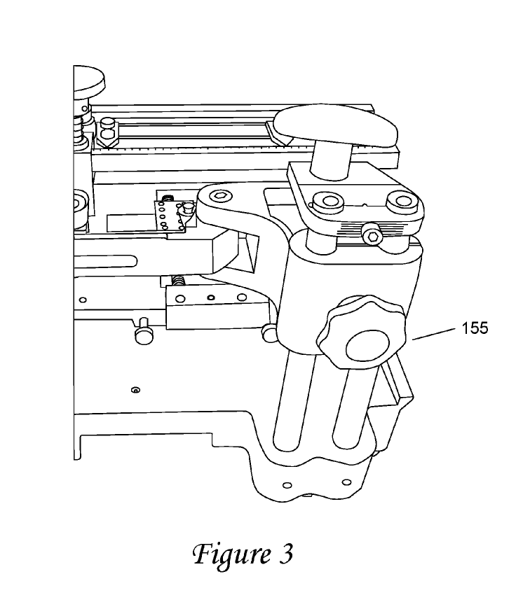

In FIGS. 2 and 3, an elongated neck portion 203 of the turn knob 202 is shown, making the user action of turning the knob 202 easier.

A control knob 155 is clearly seen in FIG. 3. Traditionally, to adjust the height of an arm on an engraving machine, a user first has to loosen this control knob 155, then move the arm 100 up/down to the desired height. This is sort of hazardous as the weight of the arm 100 must be carried by a user during the process of changing the height.

With present invention, when the height is being adjusted, control knob 155 is loosened, a user then proceed to manipulate the turn knob 202 which is fittingly engaged with the base portion 110 of the arm 100 by a correspondingly sized threaded hole 110.

That way, the actual up/down adjustment of arm 100 is achieved by the steady and fine-tuning style turning of the turn knob 202, achieving high precision and better safety for users in the industry.

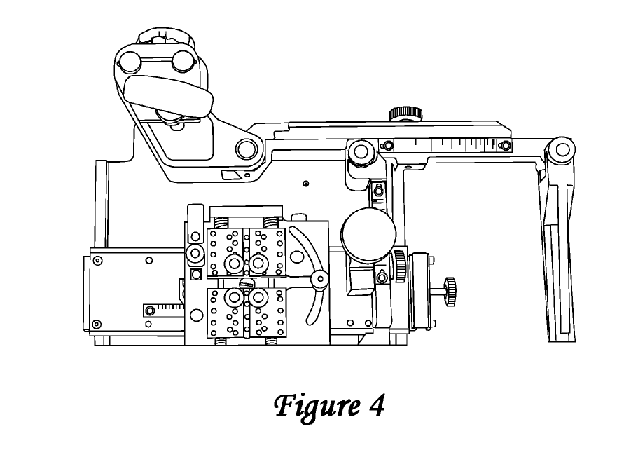

FIG. 4 shows the present invention as seen from top of an engraving machine.

What is claimed is:

1. Height adjustment device for the arm of an engraving machine, comprising:
a. A holding piece situated on top of an engraving machine's guideposts to which an engraving arm is slidably affixed;
b. A turn-knob having threaded segment fittedly spiraling through a corresponding threaded hole on the base portion of an engraving arm; and,
c. Said holding piece is so shaped to have an aperture allowing top portion of said turn-knob to be turned or handled by human hand without changing said turn-knob's vertical displacement relative to said holding piece.

2. The device of claim 1, wherein said turn-knob has an elongated neck portion containing no machined threads to make turning easier.
